(19) United States
(12) Patent Application Publication
(10) Pub. No.: US 2014/0263935 A1
(43) Pub. Date: Sep. 18, 2014

(54) Automotive Engine Support Stand

(71) Applicant: Jeffrey Coster, Manteno, IL (US)

(72) Inventor: Jeffrey Coster, Manteno, IL (US)

(21) Appl. No.: 13/826,605

(22) Filed: Mar. 14, 2013

(51) Int. Cl. F16M 11/24

(52) U.S. Cl. CPC F16M 11/24
USPC 248/676

(57) ABSTRACT

This present invention provides a supporting device to be used in lifting and supporting an automotive vehicle engine during repair of the engine. The support device has a middle plate having a threaded aperture extending through the middle plate. The middle plate is above a lower base and the middle plate is supported by a plurality of legs on the lower base. A threaded shaft extends through the aperture in the middle plate and through a threaded middle grip attached to the middle plate. A substantially flat engine support platform is rotatably mounted on an upper end of the threaded shaft by the repair mechanic. Another grip permanently engages the threaded shaft and facilitates the rotation of the threaded shaft. A ball bearing is used to allow minor adjustments to the angle and position the engine as the engine is being lifted by the support device.

### FIELD OF THE INVENTION

This application relates to engine support stands and, more particularly, to engine support stands for repairing or removal of automotive engines.

### BACKGROUND OF THE INVENTION

Jack stands are commonly used for supporting a raised load, such as supporting a raised motor vehicle so that the shop personnel may perform repair and maintenance work on the vehicle.

Many of the major maintenance or repair operations on a motor vehicle are only possible after removal of the engine from vehicle. These major operations include, among others, the renewal of crankshaft main bearings, the removal and refitting of the crankshaft, and removal and refitting of the intermediate shaft. The engine of a motor vehicle is connected to the vehicle's frame via engine mounts, usually made of rubber and metal. The metal portion connects to the engine on one side and to the frame on the other side. The rubber is between the metal portions to provide some flexibility and absorb the impact to the vehicle from the engine.

The first step of removing the engine is to lift the gearbox and the engine from the engine compartment. A hoist of 150 kg capacity will be needed to lift the engine approximately 1 meter.

Standard car jack stands cannot be used to lift the engine directly, because the substantial pressure on the jack stand produced by the weight of the engine will pierce the oil pan of the engine. Mechanics usually place a wooden block on top of a regular jack stand to lift the engine to reduce the pressure on the harmonic balancer or the oil pan.

A need exists to provide an improved jack stand that can be used directly to fully support and lift the engine without damaging or denting the engine during automotive repair and maintenance. The present invention provides an improved high rise lifting jack of the type used for repair and replacement of automobile engines and the like. Another object of the present invention is to provide a supporting device that can provide minor adjustment of the angle and position of the engine as the engine is being lifted. Yet another object of the present invention is to provide fine tuning of the height of the engine being lifted.

### BRIEF SUMMARY OF THE INVENTION

The invention provides a supporting device to be used in lifting and supporting an automotive vehicle engine during repair of the engine. The support device has a middle plate having an internally threaded aperture extending through the middle plate. The middle plate is located above a lower base and the middle plate is supported by four legs extending between the lower base and the middle base. The device also has a vertically oriented threaded shaft extending through the aperture in the middle plate and an internally threaded middle reinforcing grip fixed to the underside of the middle plate. The threads of the vertically oriented shaft engage the threads of the threaded aperture in the middle plate and in the middle grip. A substantially flat engine support platform is rotatably mounted on an upper end of the threaded shaft. Another grip permanently engages the threaded shaft and facilitates the rotation of the threaded shaft by the mechanic. A ball bearing is located between the top end of the threaded shaft and the underside of the flat engine support platform to allow minor adjustments to the angle and position of the engine when the supporting device is supporting the engine.

### BRIEF DESCRIPTION OF THE DRAWINGS

The features of the present invention which are believed to be novel are set forth with particularity in the appended claims. The invention may best be understood from the following detailed description of currently illustrated embodiments thereof taken in conjunction with the accompanying drawings wherein like numerals refer to like parts, and in which:

FIG. 1 is a perspective view of the engine support stand of the present invention.

FIG. 2 is a bottom plan view from the bottom of the engine support stand.

FIG. 3 is a cross sectional view of the engine support stand of FIG. 2, taken along line 3-3 of FIG. 2.

FIG. 4 is a partial side cross section view of the top end of the threaded shaft having a ball bearing supporting the engine support platform.

### DETAILED DESCRIPTION OF THE INVENTION

Standard jacks are designed to lift the car frames. The bottom of a car engine, such as the oil pan, is generally made from a different material that is thinner and weaker than the material used for manufacturing the car frame. The bottom of the engine, including the oil pan, would be damaged or dent if a standard jack is used directly to lift the engine because of the great pressure produced by the weight of the engine on the limited area of the top surface of the standard jack.

Referring to FIG. 1, an engine support stand 10 for raising and supporting an automotive vehicle engine is shown. The engine support stand 10 is adapted to support a fully assembled 4-wheel drive engine unit, including the transfer case and the motor vehicle transmission support bracket, independently of a motor vehicle. The engine stand 10 is comprised of an engine support platform 12, a middle plate 14, and a lower base 16. The middle plate 14 is supported above the lower base 16 by four supporting legs 15. The four supporting legs 15 are connected to the four corners of the lower base 16 and support the middle plate 14. The supporting legs 15 are made of angle iron constructed to support a load weight in the range of two hundred to three hundred pounds.

The engine support platform 12 is used to fully support and lift the engine without damaging or denting the engine. The underside of the engine support platform 12 is rotatably mounted on the end of a threaded shaft 18. The upper surface 41 (FIG. 4) of the engine support platform 12 is substantially flat, and the engine support platform 12 has an upper surface 41 area larger than standard jacks. The surface area of the engine support platform 12 is adapted to fully support the bottom of the engine to be lifted and to spread the load of the engine over the entire area of the upper surface of the engine support platform 12.

In the illustrated embodiment, the upper surface 41 of the engine support platform 12 is rectangular and in the size range of 4×6 inches. Larger surface areas facilitate the distribution of pressure on the bottom of the engine and the surface of the support platform 12, therefore protecting the engine from piercing by the jack stand. Denting on the bottom surface of the engine is substantially eliminated, when the surface area of the support platform 12 is larger than the bottom surface of the engine, and the surface of the support platform 12 is in full contact with the entire bottom surface of the engine during the lifting process.

The height of the engine support platform 12 is adjustable by rotating the threaded shaft 18. An upper grip 11 is permanently attached to the shaft 18 and cannot be moved with respect to the shaft 18. When the upper grip 11 is rotated, shaft 18 rotates with the grip 11 to adjust the height of the support platform 12. A wrench or other suitable means as are known in the art can be used to grab the grip 11 and rotate the grip 11 and shaft 18.

Referring to FIGS. 2 and 3, FIG. 2 is a bottom-up view from the bottom of the engine support stand with bottom plate 16 removed, and FIG. 3 is a cross sectional view of the engine support stand of FIG. 2, taken along line 3-3 of FIG. 2, and with the bottom plate 16 in place. The four legs 15 extend from the four corners of the middle plate 14 to the corresponding four corners of the lower base 16. A threaded aperture 21 extends through the center of the middle plate 14, and the threaded shaft 18 extends through the threaded aperture 21 of the middle plate. The internal threads in aperture 21 fit with the external threads on the threaded shaft 18, therefore the middle plate 14 can hold the shaft 18 when the device is used in lifting an engine. Rotation of the threaded shaft 18 raises and lowers the top threaded shaft 18 relative to the middle plate 14.

A middle grip 23 is used to further support the shaft 18 as the shaft rotates in aperture 21 during lifting and support of the engine. As shown in FIG. 3, the middle grip 23 is permanently attached to the bottom of the middle plate 14. The center aperture of middle grip 23 opens to the aperture 21 in the middle plate 14, and allows the shaft 18 to extend through the middle grip 23. When the shaft 18 is rotated to adjust the height of the support platform 12, the shaft 18 is also raised or lowered with respect to the middle plate 14 and the middle grip 23.

The shaft 18 used in the present invention is different from the shafts used in prior art jack stands. The threaded shaft 18 used in the present invention works in a couple with grips 23 and 11 to adjust the desired height of the shaft 18 with precision. Prior art references use apertured rod members and locking pins to adjust the height of the shaft. A locking pin can be extended through one of the plurality of apertures in the shaft to lock the rod member at a desired height. A threaded shaft is not used in previous standard jacks because standard jacks are used to support the car frame. The weight of a car greatly exceeds the weight of the car engine, therefore threaded shafts are not suitable for use in supporting a car. A locking pin system can secure the heavier auto frame, while a threaded shaft may not be suitable to support the weight of the vehicle.

The present invention is particularly used for supporting the car engine when repairing the engine. With respect to the most common type of engines that are mounted to the vehicle with front and rear engine mounts, the engine mounts are removable and displaceable in relation to the vehicle. The engine can be partially lifted during repair, where the engine is lifted off one or two of the engine mounts, and the remaining two or three engine mounts still carry part of the weight of the engine. The threaded shaft 18 of the present invention is suitable for an engine support stand particularly designed for lifting an engine during repair. The threaded shaft 18 also provides fine tuning of the height of the shaft to ⅛ of an inch, instead of where in using a standard jack, the height is limited due to the locking pin and the position of the apertures receiving the locking pin. When repairing the engine with the present invention, the machinist can lift the engine to variable heights accordingly, depending on the repair parameters and protocols.

FIG. 4 is a partial side view of the engine support platform 12 supported at the top end of the threaded shaft, and having a ball bearing 40 supporting the engine support platform 12. The engine support platform 12 has two reinforcement collars 43 extending downwardly from the two edges of the engine support platform 12. The upper surface 41 of the engine support platform 12 can be covered by a rubber resistance pad to provide a cushion for the supported engine and also prevent slippage. The upper surface 41 is adapted to apply a maximum pressure force to an underside of the vehicle engine in the range of ten pounds per square inch to twenty pounds per square inch. The two collars 43 together with the upper surface 41 form a reversed U shape structure to better support the engine.

Ball bearing 40 is placed in a groove 42 in the shaft 18, and between the engine support platform 12 and the top of shaft 18. The ball bearing 40 creates a hollow space between the top of the shaft 18 and bottom of the engine support platform 12, therefore allowing the tilting up and down and rotation of the engine in repair, if necessary.

While one particular embodiment of a support device for raising and supporting an automotive vehicle engine during repair of the engine of the present invention has been shown and described, it will be apparent to those skilled in the art that changes and modifications may be made without departing from the true spirit and scope of the present invention. It is the intent of the appended claims to cover all such changes and modifications as fall within the true spirit and scope of the invention.

I claim:

1. A support device for raising and supporting an automotive vehicle engine during repair of the engine, the support device comprising:
a middle plate having a threaded aperture extending through the middle plate;
said middle plate supported above a lower base by at least one support leg extending between the middle plate and the lower base;
a threaded shaft extending through the aperture in the middle plate, the threads of the shaft engaging the threads of the threaded aperture;
a substantially flat engine support platform rotatably mounted on an upper end of the threaded shaft; and
an upper grip permanently engaging the threaded shaft, said upper grip facilitating the rotation of the threaded shaft.

2. The support device of claim 1, wherein said engine support platform has two reinforcing collars extending downwardly from two opposed edges of the engine support platform.

3. The support device of claim 1, wherein said engine support platform is rectangular.

4. The support device of claim 1, wherein the engine support platform has an upper surface covered by a resistant pad.

5. The support device of claim 1, wherein a ball bearing is located on the top of the threaded shaft and underneath the engine support platform, said ball bearing providing tilt and swivel motion of said engine support platform.

6. The support device of claim 1, comprising a middle grip attached to said middle plate, said middle grip having a threaded aperture axially aligned with the threaded aperture in the middle plate, said threaded shaft rotatably engaging the threaded apertures in both the middle plate and the middle grip.

7. The support device of claim 6, wherein the upper grip is located at an upper portion of the threaded shaft in between the middle grip and the engine support platform.

8. The support device of claim 1, wherein four supporting legs support the middle plate on said lower base, said supporting legs made of angle iron adapted to support a load weight in the range of two hundred to three hundred pounds.
